(19) United States
(12) Patent Application Publication
(10) Pub. No.: US 2012/0281747 A1
(43) Pub. Date: Nov. 8, 2012

(54) EQUALIZER TAP DETERMINATION

(75) Inventors: Farrokh Abrishamkar, San Diego, CA (US); Aditya Dua, Santa Clara, CA (US)

(73) Assignee: QUALCOMM Incorporated, San Diego, CA (US)

(21) Appl. No.: 13/099,117

(22) Filed: May 2, 2011

(51) Int. Cl. H04L 27/06; H04L 27/01

(52) U.S. Cl. 375/232

(57) ABSTRACT

A method includes performing an operation based on transformed channel data and transformed signal data to generate a transform representation of multiple taps. The transformed channel data and the transformed signal data correspond to data received at a receiver. An inverse transform of the transform representation is determined to generate multiple taps for use at an equalizer of the receiver. At least one of the multiple taps is discarded to generate updated filter taps for the equalizer.

### FIELD

The present disclosure is generally related to equalizers.

### BACKGROUND

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet Protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player.

Such portable computing devices may use an equalizer to adjust received signals to compensate for noise, interference, and multipath delay. One such equalizer may use a “linear minimum mean squared error” (LMMSE) equalization technique to adjust the received signals by reducing an energy difference between received and transmitted signals. For example, the LMMSE equalizer may use a filter that includes coefficients or taps selected to reduce a difference in energy between the received signal and its transmitted counterpart. However, the LMMSE technique may involve computationally complex operations, such as inversion of an auto-covariance matrix.

### SUMMARY

LMMSE equalizer taps are approximately determined using a computationally inexpensive frequency domain operation. To determine the equalizer taps, a channel impulse response vector of size J and an auto-covariance matrix of size J×J are determined based on a received signal. The size of the channel impulse response vector and the size of the auto-covariance matrix may be increased, such as through zero padding, to generate a channel impulse response vector of size N and an auto-covariance matrix of size N×N, where N>J.

A circulant approximation of the size N×N auto-covariance matrix may be determined in order to avoid complexity associated with inverting the auto-covariance matrix. The size-N channel impulse response vector and the size-N×N circulant approximation matrix may be transformed to the frequency domain, such as by use of a fast Fourier transform routine. A frequency domain operation may then be performed based on the transformed size-N channel impulse response vector and the transformed size-N×N auto-covariance matrix to generate a transform representation of N taps for use at an equalizer of a receiver. The transform representation may then be inversely transformed to yield updated filter taps for the equalizer.

Because the equalizer is configured to use J taps, where N>J, at least one of the updated filter taps may be discarded. The taps to be retained may be selected based on various selection examples, such as a middle tap example, a maximum energy example, a greedy example, or a maximum signal-to-noise ratio (SNR) example. The taps may be generated using a fast Fourier transform (FFT) routine, which is amenable to efficient implementation. The taps may be generated without inversion of the auto-covariance matrix. Further, increasing the size of the auto-covariance matrix to size N×N may reduce errors associated with the circulant approximation.

In a particular embodiment, a method includes receiving a signal at a receiver via a communication channel. An N-point transform of channel data associated with the communication channel is determined to generate transformed channel data. An N-point transform of signal data associated with the received signal is also determined to generate transformed signal data. An operation based on the transformed channel data and the transformed signal data is performed to generate a transform representation of multiple taps. An N-point inverse transform of the transform representation is determined to generate multiple taps for use at an equalizer of the receiver. At least one of the multiple taps is discarded to generate updated filter taps for the equalizer.

In another embodiment, an apparatus includes a receiver including a J-tap equalizer and an N-point transform circuit coupled to the receiver. The J-tap equalizer receives channel data and signal data from the receiver, where N is greater than J. The apparatus further includes a tap calculator that is coupled to receive transformed channel data output from the N-point transform circuit and to receive transformed signal data from the N-point transform circuit. The tap calculator includes a discarder circuit, where an output of the discarder circuit is coupled to provide J updated filter taps to the J-tap equalizer.

In another embodiment, an apparatus includes means for receiving a signal via a communication channel. The means for receiving includes an equalizer. The apparatus further includes means for determining an N-point transform of channel data associated with the communication channel to generate transformed channel data and means for determining an N-point transform of signal data associated with the received signal to generate transformed signal data. The apparatus further includes means for performing an operation based on the transformed channel data and the transformed signal data to generate a transform representation of multiple taps. The apparatus further includes means for determining an N-point inverse transform of the transform representation to generate multiple taps for use at an equalizer of the receiver and means for discarding at least one of the multiple taps to generate updated filter taps for the equalizer.

In another embodiment, a tangible computer readable medium includes instructions executable by a processor to cause the processor to receive a signal at a receiver via a communication channel. The instructions are further executable by the processor to determine an N-point transform of channel data associated with the communication channel to generate transformed channel data and to determine an N-point transform of signal data associated with the received signal to generate transformed signal data. The instructions are further executable by the processor to perform an operation based on the transformed channel data and the transformed signal data to generate a transform representation of multiple taps. The instructions are further executable by the processor to determine an N-point inverse transform of the transform representation to generate multiple taps for use at an equalizer of the receiver and to discard at least one of the multiple taps to generate updated filter taps for the equalizer.

In another embodiment, a system includes a communication device. The communication device includes a receiver that receives a signal via a communication channel, where the receiver includes an equalizer. The communication device also includes a transform circuit that determines an N-point transform of channel data associated with the communication channel to generate transformed channel data and determines an N-point transform of signal data associated with the received signal to generate transformed signal data. The communication device further includes a tap calculator that performs an operation based on the transformed channel data and the transformed signal data to generate a transform representation of multiple taps. The transform circuit further performs an N-point inverse transform of the transform representation to generate multiple taps for use at an equalizer of the receiver. The tap calculator includes a discarder circuit that discards at least one of the multiple taps to generate updated filter taps for the equalizer. The system further includes a network device, where the network device transmits the signal to the communication device via the communication channel.

In another embodiment, a semiconductor device includes an N-point transform circuit that receives channel data and signal data and a tap calculator that receives transformed channel data and transformed signal data from the N-point transform circuit. The tap calculator is coupled to provide J updated filter taps to a J-tap equalizer, where J is greater than N.

In another embodiment, a method includes performing an operation based on transformed channel data and transformed signal data to generate a transform representation of multiple taps. The transformed channel data and the transformed signal data correspond to data received at a receiver. An inverse transform of the transform representation is determined to generate multiple taps for use at an equalizer of the receiver. At least one of the multiple taps is discarded to generate updated filter taps for the equalizer.

### BRIEF DESCRIPTION OF THE DRAWINGS

FIG. 1 is a general diagram of a particular illustrative embodiment of a system including a wireless device having a tap calculator to discard one or more of N calculated taps for a J-tap equalizer;

FIG. 2 is a data flow diagram of a particular illustrative embodiment of a process to discard one or more of N calculated taps for a J-tap equalizer;

FIG. 3 is a block diagram of a particular illustrative embodiment of the wireless device that may be used in the system of FIG. 1;

FIG. 4 is a flow diagram of a particular illustrative embodiment of a method of generating multiple taps for an equalizer of a receiver; and

FIG. 5 is a block diagram of a particular illustrative embodiment of a wireless device that includes a tap calculator that is configured to discard one or more of N calculated taps for a J-tap equalizer.

### DETAILED DESCRIPTION

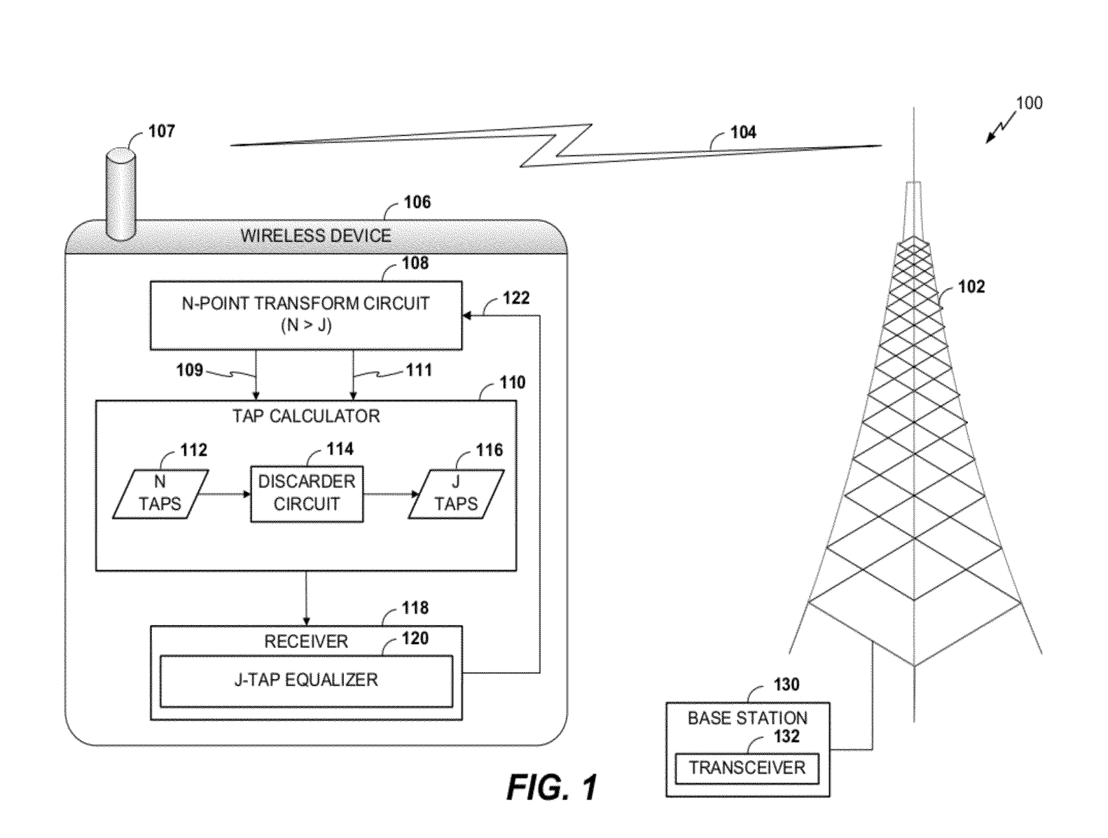

FIG. 1 is a general diagram of a particular illustrative embodiment of a system 100. The system 100 includes a radio tower 102 and a wireless device 106. The radio tower 102 is coupled to a base station 130 and is configured to transmit a signal 104 to a wireless device 106 via a communication channel, such as a wireless communication channel. The radio tower 102 may transmit the signal 104 using a transceiver, such as a transceiver 132 of the base station 130. The base station 130 may be a multiple transceiver device.

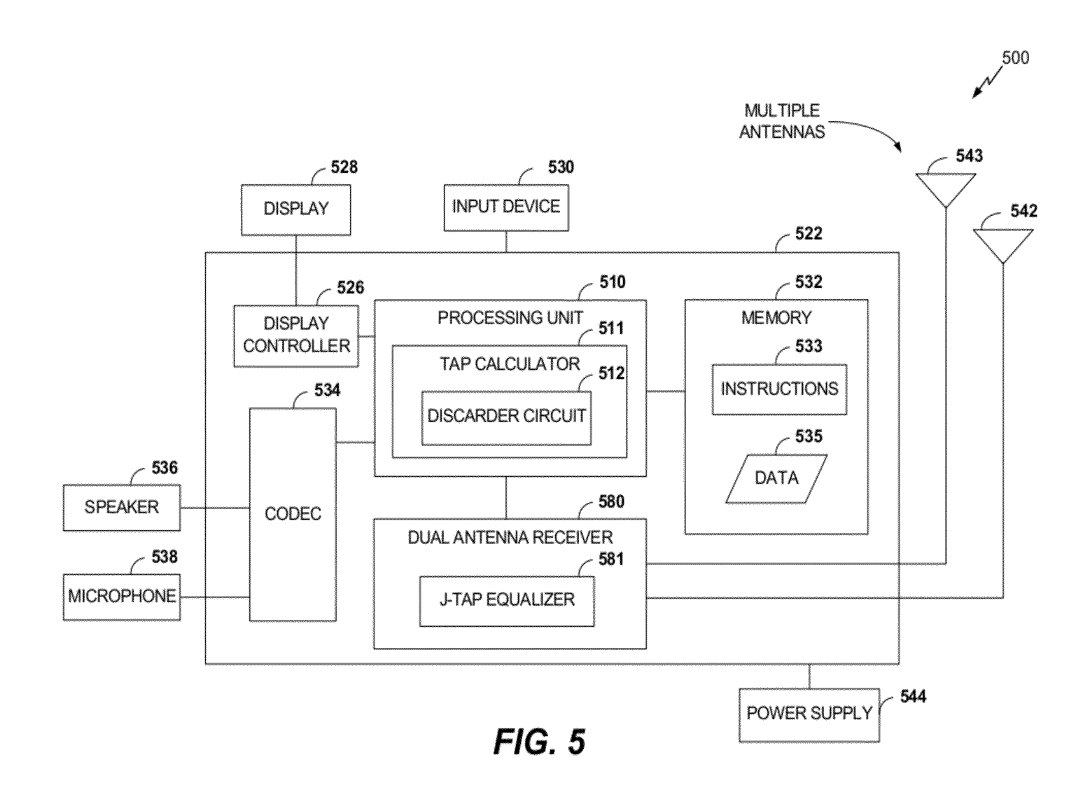

The wireless device 106 may include a receiver 118 operable to receive the signal 104 from the radio tower 102. The receiver 118 may include a J-tap equalizer 120. An antenna 107 may be coupled to the receiver 118. The antenna 107 may be a single antenna or may include multiple antennas, as described further with reference to FIG. 5. The antenna 107 may be an internal antenna or an external antenna.

The wireless device 106 may further include a transform circuit 108 and a tap calculator 110. The transform circuit 108 may be configured to perform N-point transforms. The tap calculator 110 may include a discarder circuit 114.

In operation, the radio tower 102 may transmit the signal 104 to the wireless device 106. The wireless device 106 may use the receiver 118 to receive the signal 104 via the antenna 107. In response to receiving the signal 104, the receiver 118 may generate data. For example, the receiver 118 may generate a channel impulse response vector that indicates a channel characteristic of the wireless communication channel over which the signal 104 was sent to the receiver 118. The receiver 118 may further generate signal data, such as an auto-covariance matrix that indicates a statistical property of the signal 104 (e.g., a self-interference characteristic of the signal 104).

The data 122 generated by the receiver 118 (e.g. data corresponding to the channel and data corresponding to the signal 104) may be provided to the transform circuit 108. The transform circuit 108 may be configured to perform N-point transforms. For example, the transform circuit 108 may perform an N-point fast Fourier transform (FFT) of channel data to generate transformed channel data 109. The transform circuit 108 may perform an N-point fast Fourier transform (FFT) of signal covariance data to generate transformed signal covariance data 111.

The tap calculator 110 may receive the transformed channel data 109 and the transformed signal covariance data 111 from the transform circuit 108. The tap calculator 110 may generate N taps 112. The discarder circuit 114 may discard at least one of the N taps to generate updated filter taps for the J-tap equalizer 120, yielding J taps 116, where N is greater than J. The J taps 116 may be provided to the J-tap equalizer 120. The J-tap equalizer 120 may use the J taps 116 for reception and equalization of wireless signals, for example as coefficients of a digital filter that equalizes received signals, such as a finite impulse response (FIR) filter.

Although the tap calculator 110 and the J-tap equalizer 120 are illustrated in a mobile device in the system 100, in other embodiments the tap calculator 110 and the J-tap equalizer 120 may be implemented in a wired device such as a digital subscriber line (DSL) modem. According to another illustrative embodiment, a base station or a base station transceiver, such as the base station 130 or the transceiver 132, may incorporate tap calculator 110 and the J-tap equalizer 120.

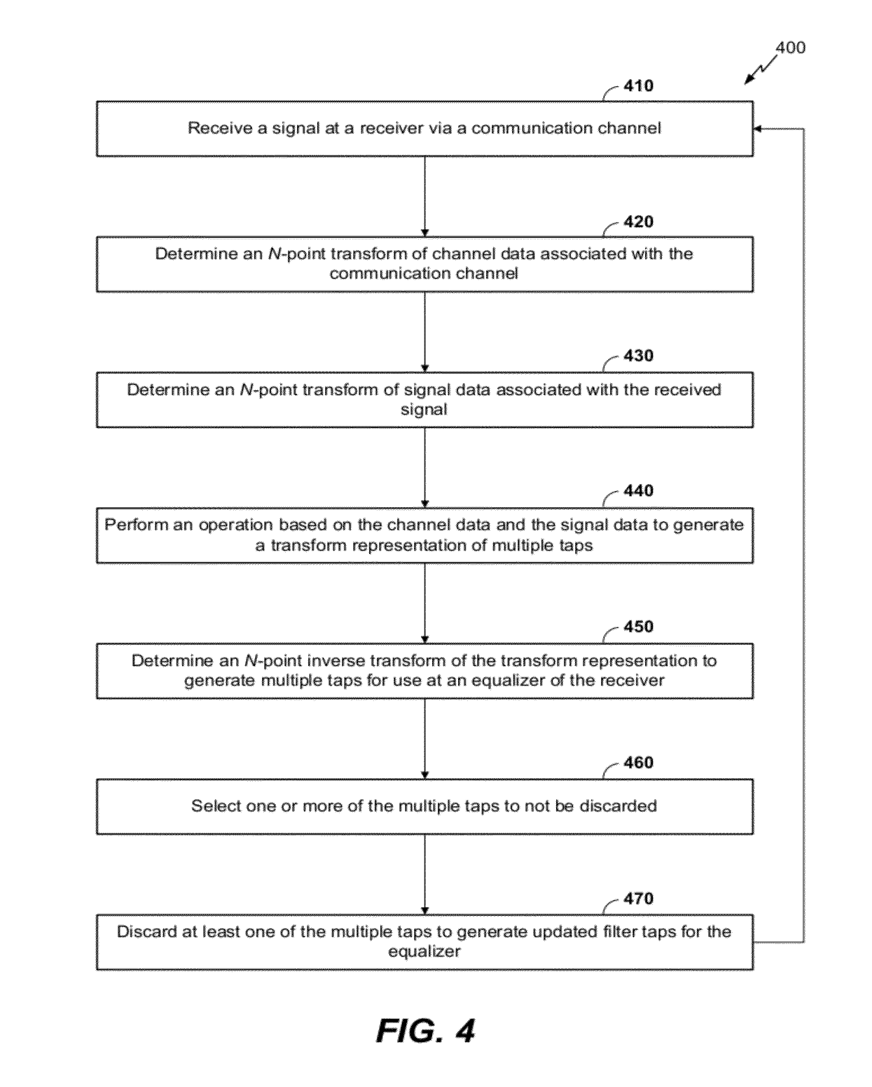

It will be appreciated that discarding at least one of the N taps to generate J taps for use at the J-tap equalizer 120 may reduce power consumption by the wireless device 106. Because the wireless device 106 may benefit from efficient use of resources and may operate in accordance with battery management constraints, it may be preferable to use J taps rather than N taps in order to reduce receiver complexity. As described further with reference to FIG. 4, the J taps may be selected in order to improve performance of a wireless device.

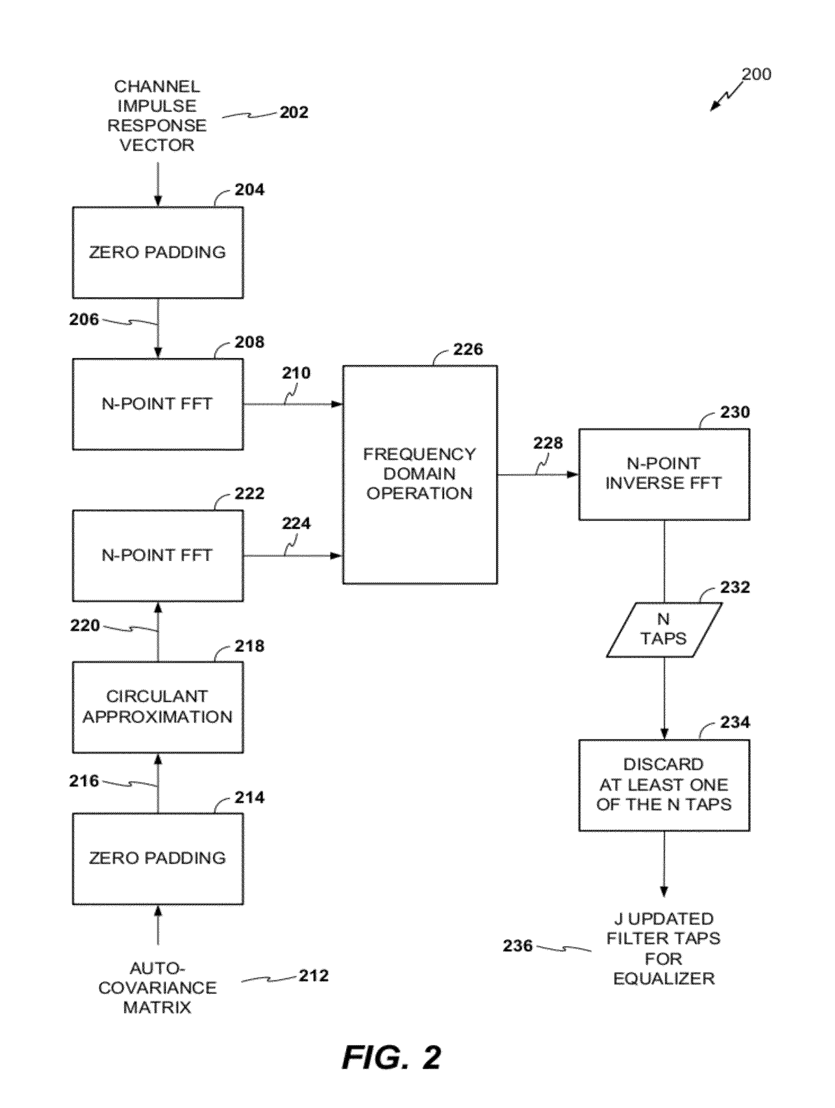

FIG. 2 is a data flow diagram of a particular illustrative embodiment of a process 200 that may be performed by an apparatus, such as the wireless device 106 of FIG. 1. According to another illustrative embodiment, the process 200 is used by a wired device, such as a digital subscriber line (DSL) modem. According to another illustrative embodiment, the process 200 is used by a network device, such as a base station. The process 200 may be utilized by a wideband communication system or network, such as an Evolution-Data Optimized (EV-DO) network, a Wideband Code Division Multiple Access (W-CDMA) network, or a Time Division Synchronous Code Division Multiple Access (TD-SCDMA) network. The process 200 may be utilized in a device where an equalizer is used to compensate for effects of a frequency-selective channel.

A signal, such as the signal 104 of FIG. 1, may be received by a device via a communication channel. The signal may be transmitted by a base station, such as the radio tower 102 of FIG. 1. The received signal may be represented as:

$$y ( n ) = {\sum }_{k = 0}^{K - 1} h ( k ) x ( n - k ) + w ( n )$$

where y(n) is the signal received, h(k) is the kth tap of the communication channel, x(n) is the signal transmitted by the base station, and w(n) is additive thermal noise and interference from other devices.

A channel impulse response vector 202 associated with the communication channel may be determined For example, pilot symbols received with the signal may be used to determine the channel impulse response vector 202. The channel impulse response vector 202 may be a vector represented as \vec{h}.

A zero padding operation 204 may be performed on the channel impulse response vector 202 to generate channel data 206. According to a particular illustrative embodiment, N=2 J. However, according to other embodiments, N can be any integer such that N>J. According to a particular illustrative embodiment, zeroes are added to the beginning and to the end of the channel impulse response vector 202. Thus, if N=2 J, and zeroes are to be added to the beginning and to the end of the channel impulse response vector 202, the channel data 206 may therefore be given by:

$${\vec{h}}^{′} = {[ \begin{matrix}{0}_{J / 2 \times 1} \\ \vec{h} \\ {0}_{J / 2 \times 1}\end{matrix} ]}_{2 J \times 1}$$

where \vec{h}′ is the channel impulse response vector 202 after zero padding.

In other embodiments, zeroes are added to only the beginning of the channel impulse response vector 202, to only the end of the channel impulse response vector 202, or at other locations of the channel impulse response vector 202.

An N-point fast Fourier transform (FFT) operation 208 may be performed on the channel data 206 to generate transformed channel data 210.

An auto-covariance matrix 212 associated with the received signal may be determined. The auto-covariance matrix 212 may indicate a statistical characteristic of the signal, such as a self-interference characteristic. Assuming that the received signal is wide-sense stationary (WSS), the auto-covariance matrix 212 may be given by:

$$R = {[ \begin{matrix}R ( 0 ) & {R}^{*} ( 1 ) & … & {R}^{*} ( J / 2 - 1 ) & 0 & … & 0 \\ R ( 1 ) & R ( 0 ) & … & {R}^{*} ( J / 2 - 2 ) & {R}^{*} ( J / 2 - 1 ) & … & 0 \\ ⋮ & ⋮ & & & ⋱ & ⋱ & \\ 0 & 0 & … & 0 & … & R ( 1 ) & R ( 0 )\end{matrix} ]}_{J \times J}$$

A zero padding operation 214 may be performed on the auto-covariance matrix 212 to generate a zero-padded auto-covariance matrix (R′) 216 of size N×N. According to a particular illustrative embodiment, N=2 J, so that the zero-padded auto-covariance matrix (R′) 216 is of size 2 J×2 J. The zero padding operation 214 may be similar to the zero padding operation 204. The zero-padded auto-covariance matrix 216 may have a Toeplitz structure that can be represented using a circulant approximation.

A circulant approximation operation 218 may be performed on the zero-padded auto-covariance matrix 216 to generate signal covariance data 220. In a particular illustrative embodiment, the signal covariance data 220 is a circulant approximation matrix (R_{c}′). Because circulant matrices can be diagonalized by a discrete Fourier transform, the circulant approximation operation 218 may be represented as:

R_{c}′=F_{N}^{H}D′F_{N}

where F_{N} is a Fourier transform matrix of size N×N, D′ is a diagonal matrix of size N×N with real, positive entries, and F_{N}^{H} is the Hermitian (i.e., conjugate transpose) of the Fourier transform matrix F_{N} of size N×N. Since F_{N} is by definition a unitary matrix and D′ is a diagonal matrix, an inverse of the circulant approximation matrix may be given by:

(R′_{c})¹=F_{N}^{H}(D′)¹F_{N}

Because D′ is a diagonal matrix, determining (R′_{c})⁻¹ (as explained further below) may be significantly less computationally expensive than determining R⁻¹. For example, (D′)⁻¹ may be computed by inverting each diagonal element of D′.

An N-point FFT operation 222 may be performed on the signal covariance data 220, such as the circulant approximation matrix, to generate transformed signal covariance data 224.

A frequency domain operation 226 may be performed based on the transformed channel data 210 and the transformed signal covariance data 224. The frequency domain operation 226 may generate a transform representation 228 of multiple taps.

An N-point inverse FFT operation 230 may be performed on the transform representation 228 to generate N taps 232 for use at an equalizer.

The frequency domain operation 226 and the N-point inverse FFT operation 230 may be included in a single operation. For example, according to a particular illustrative embodiment, the frequency domain operation 226 and the N-point inverse FFT operation 230 are performed according to:

\vec{c}′_{FDE}=(R′_{c})⁻¹\vec{h}′=F_{N}^{H}(D′)⁻¹F_{N}\vec{h}′

where F_{N}^{H} is an inverse Fourier transform matrix and \vec{c}′_{FDE} is a time domain vector that includes the N taps 232 for use at the equalizer. Because D′ is a diagonal matrix, a computational complexity may be reduced by calculating (R′_{c})⁻¹\vec{h}′ as compared to calculating R⁻¹\vec{h}.

A discard operation 234 may be performed on the N taps 232 to discard at least one of the N taps 232. The excess taps, i.e., N-J taps, may be discarded (e.g., deleted). The discard operation 234 may generate J updated filter taps 236 for the equalizer. Selection of the J taps is described in more detail with reference to FIG. 4.

It will be appreciated that the process 200 may enable accurate calculation of equalizer taps. In particular, because an auto-covariance matrix and a channel impulse response vector are increased in size from J to N, an error associated with the circulant approximation is reduced. A number of computed taps may thereafter be reduced, for example by reducing the number of computed taps from N to J by discarding at least one of the computed taps. The process 200 may be performed without inversion of an auto-covariance matrix. The process 200 may be performed in the frequency domain using a fast Fourier transform operation and an inverse fast Fourier transform operation, which may be efficiently implemented by hardware, by executing processor-executable instructions, or a combination thereof.

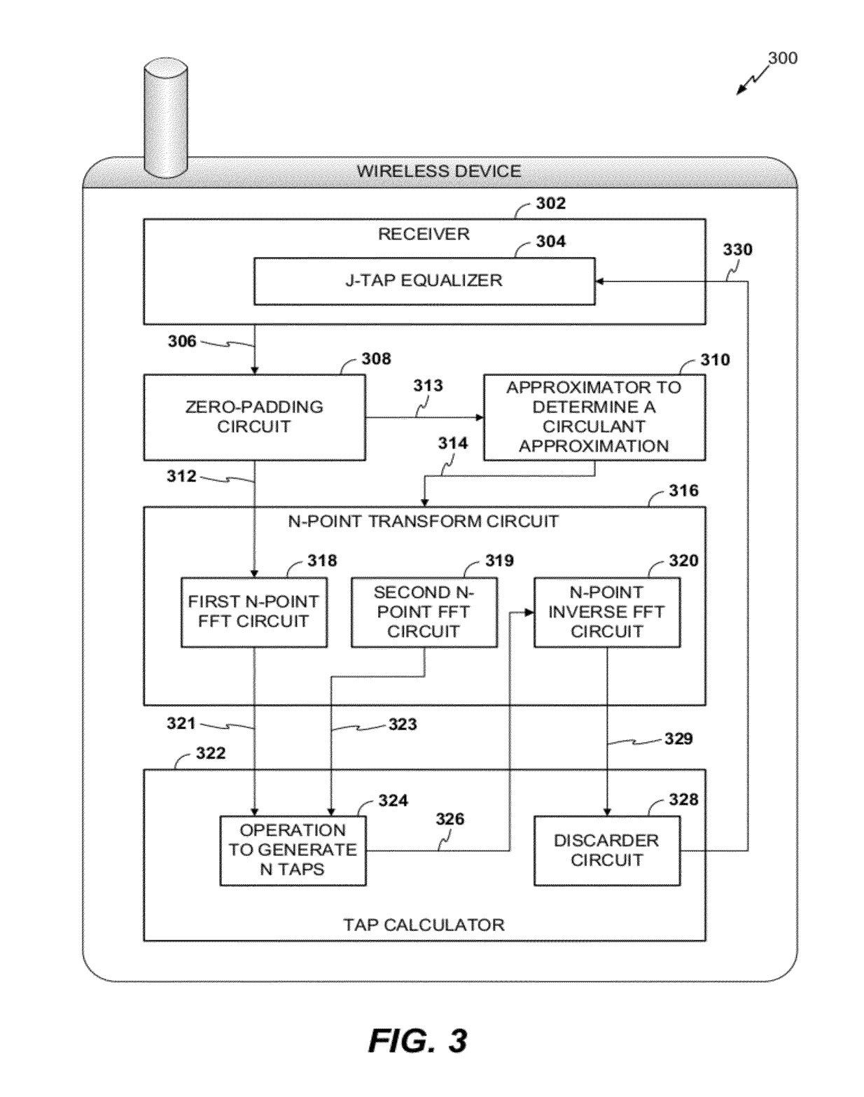

FIG. 3 is a diagram of a particular illustrative embodiment of a wireless device 300. The wireless device 300 may include components that perform the process 200 of FIG. 2. In a particular embodiment, the wireless device 300 is the wireless device 106 of FIG. 1.

The wireless device 300 may include a receiver 302, a zero padding circuit 308, an approximator 310, a transform circuit 316, and a tap calculator 322. The receiver 302 may be configured to receive a signal and to generate data 306 in response to the signal. The data 306 may include a channel impulse response vector and an auto-covariance matrix. The receiver 302 may include a J-tap equalizer 304 that is configured to use J taps, e.g., as coefficients of a finite impulse response (FIR) filter that performs equalization of received signals. The receiver 302 may be a single antenna device or, as described with reference to FIG. 5, the receiver 302 may be a multiple antenna device.

The zero padding circuit 308 may be coupled to receive the data 306 from the receiver 302. The zero padding circuit 308 may be coupled to the approximator 310 and to the N-point transform circuit 316. For example, the zero padding circuit 308 may be coupled to provide a zero-padded auto-covariance matrix 313 to the approximator 310 and may be coupled to provide channel data 312 to the N-point transform circuit 316. To illustrate, the zero padding circuit 308 may be configured to perform the zero padding operation 204 and the zero padding operation 214 of FIG. 2.

The approximator 310 may be configured to determine a circulant approximation of the zero-padded auto-covariance matrix 313. Determining the circulant approximation of the zero-padded auto-covariance matrix 313 generates signal covariance data 314. For example, the approximator 310 may be configured to perform the circulant approximation operation 218 of FIG. 2.

The N-point transform circuit 316 may be coupled to receive the channel data 312 from the zero padding circuit 308 and may be further coupled to receive the signal covariance data 314 from the approximator 310. The N-point transform circuit 316 may include a first N-point fast Fourier transform (FFT) circuit 318, a second N-point FFT circuit 319, and an N-point inverse FFT circuit 320. For example, the N-point transform circuit 316 may be configured to perform the N-point FFT operation 208, the N-point FFT operation 222, and the N-point inverse FFT operation 230 of FIG. 2.

The tap calculator 322 may be coupled to receive transformed channel data output from the first N-point FFT circuit 318. The tap calculator 322 may be further coupled to receive transformed signal covariance data from the second N-point FFT circuit 319. The tap calculator 322 may include a discarder circuit 328. The tap calculator 322 may be coupled to the receiver 302. The tap calculator 322 may be configured to generate a transform representation of multiple taps and to discard at least one tap to generate updated filter taps for the J-tap equalizer 304. For example, the tap calculator 322 may perform the frequency domain operation 226 and the discard operation 234 of FIG. 2.

In operation, the wireless device 300 may receive a wireless signal. The receiver 302 of the wireless device 300 may process the received wireless signal to generate the data 306. The zero padding circuit 308 may receive the data 306 and may zero-pad the data 306 to generate the channel data 312 and the zero-padded auto-covariance matrix 313. The approximator 310 may determine a circulant approximation of the zero-padded auto-covariance matrix 313 to generate the signal covariance data 314.

The N-point transform circuit 316 may receive the channel data 312 and the signal covariance data 314. The first N-point FFT circuit 318 may transform the channel data 312 to generate transformed channel data 321. The second N-point FFT circuit 319 may transform the signal covariance data 314 to generate transformed signal covariance data 323.

The tap calculator 322 may receive the transformed channel data 321 and the transformed signal covariance data 323 and may perform the N-tap generation operation 324 to generate a transform representation 326 of multiple taps. The tap calculator 322 may provide the transform representation 326 to the N-point inverse FFT circuit 320 of the N-point transform circuit 316.

The N-point inverse FFT circuit 320 may inversely transform the transform representation 326 to generate taps 329 for use at the J-tap equalizer 304 of the receiver 302. The N-point inverse FFT circuit 320 may provide the generated taps 329 to the discarder circuit 328. The discarder circuit 328 discards at least one of the generated taps 329 to generate J updated filter taps 330 for the J-tap equalizer 304. The discarder circuit 328 provides the J updated filter taps 330 to the J-tap equalizer 304.

It will be appreciated that the wireless device 300 of FIG. 3 may efficiently calculate equalizer taps. Signal covariance data and channel data may be transformed into the frequency domain to calculate a transform representation of multiple taps for use at an equalizer and may be thereafter converted to the time domain. Accordingly, the equalizer taps may be calculated based on Fourier transform operations that may be implemented efficiently. The equalizer taps may be calculated without inversion of a large auto-covariance matrix.

FIG. 4 is a flow diagram of a particular illustrative embodiment of a method 400 of generating multiple taps for an equalizer of a receiver. The method may be performed by the wireless device 106 of FIG. 1, the wireless device 300 of FIG. 3, or a combination thereof.

The method 400 includes receiving a signal at a receiver via a communication channel, at 410. For example, the signal may be the signal 104 of FIG. 1. The receiver may be the receiver 118 of FIG. 1.

An N-point transform of channel data associated with the communication channel is determined, at 420. For example, the N-point FFT operation 208 of FIG. 2 is performed on the channel data 206 to produce the transformed channel data 210. An N-point transform of signal data associated with the received signal is determined, at 430. For example, the N-point FFT operation 222 of FIG. 2 is performed on the signal covariance data 220 to produce the transformed signal covariance data 224.

The method 400 further includes performing an operation based on the channel data and the signal data to generate a transform representation of multiple taps, at 440. For example, the operation may be the frequency domain operation 226 of FIG. 2.

An N-point inverse transform of the generated taps is determined to generate multiple taps for use at an equalizer of the receiver, at 450. For example, the N-point inverse FFT operation 230 of FIG. 2. is performed on the transform representation 228 to generate the N taps 232.

One or more of the multiple taps (i.e., after inverse transformation to the time domain) are selected to not be discarded, at 460. The method 400 further includes discarding at least one of the multiple taps to generate updated filter taps for the equalizer, at 470. The discarding may be performed by one or more of the discarder circuit 114 of FIG. 1 and the discarder circuit 328 of FIG. 3. The method 400 may then repeat, for example in response to receiving a second signal or after a predetermined time period, to generate second updated filter taps to replace the updated filter taps at the equalizer.

Selecting one or more of the taps to not be discarded (i.e., to be retained) may be performed in a variety of ways. As a first example, a middle tap of the taps may be retained. To illustrate, for N taps, a dth tap may be selected to be retained, where d is the index of the first tap to be retained. Additional taps after the dth tap may also be retained. For example, if N=2 J and J taps are to be selected, then the J middle taps are retained and J non-middle taps are discarded, where taps with indices d, d+1, d+2, . . . d+J−1 are the retained taps.

As a second example, taps having the highest energy values may be selected to be retained. For example, each set of J consecutive taps of the N taps may be evaluated according to:

$${E}_{d} = {‖ {\vec{c}}_{sel} ‖}^{2} = {\sum }_{j = d}^{d + J - 1} {\vert {c}_{j} \vert}^{2} , d = 0 , 1 , … , ( N - J )$$

to rank the sets of taps in terms of energy values. The set of taps corresponding to the highest energy value may then be selected and the other taps may be discarded.

As a third example, taps having the highest energy values may be selected to be retained based on a “greedy” selection. The greedy selection may include iteratively comparing a pair of the N taps and discarding the tap that has the lower energy value until J taps remain. For example, a first tap of the N taps may be squared and compared to a squared Nth tap of the N taps to determine which has a higher energy value. The tap with the higher energy value may be retained and the tap with the lower energy value may be discarded. The retained tap may then be compared to a next tap. For example, after discarding a tap, a tap having a highest index value of the taps remaining may be compared to a tap having a lowest index value of the taps remaining to determine which has a higher energy value, with the tap associated with the higher energy value retained. Iteratively comparing and discarding may continue until a desired number of taps are selected, such as J of the N taps.

As a fourth example, taps may be selected based on a signal-to-noise ratio (SNR) γ_{d} at an output of the equalizer. For example, each set of J consecutive taps of the N taps may be evaluated according to:

$${g}_{d} ( n ) = {\sum }_{k = d}^{d + J - 1} c ( k ) h ( n - k ) , d = 0 , 1 , … , ( N - J )$$

where c(k) is the kth tap and h(n-k) is the (n-k)th coefficient of the channel impulse response vector.

A dth set of J taps of the N taps is evaluated based on the SNR γ_{d} at the output of the receiver according to:

$${γ}_{d} = \frac{max \{ {\vert {g}_{d} ( n ) \vert}^{2} \}}{( {\sum }_{n} {\vert {g}_{d} ( n ) \vert}^{2} - max \{ {\vert {g}_{d} ( n ) \vert}^{2} \} )}$$

After evaluating the SNR γ_{d} for each set of J consecutive taps of the N taps, the value of d corresponding to a largest evaluated SNR γ_{d} may be selected. Although the four examples of tap selection are described with respect to selection of a set of J consecutive taps of the N taps, it will be understood that the examples may be applied to selection of J non-consecutive taps of the N taps.

The tap selection employed in connection with the method 400 of FIG. 4 may be based on a performance/complexity trade-off. For example, the first example may be less computationally complex than the third example, followed by the second example, and followed by the fourth example. With regard to performance (e.g. how accurately the selected taps approximate a true LMMSE equalizer), the fourth example may exhibit better performance than the second example, followed by the third example, and followed by the first example. Accordingly, a tap selection may be determined based on performance, available processing power, battery life considerations, complexity considerations, and other design parameters.

FIG. 5 is a diagram of a particular illustrative embodiment of a wireless device 500. For example, the wireless device 500 may correspond to the wireless device 106 of FIG. 1, the wireless device 300 of FIG. 3, or a combination thereof.

The wireless device 500 may include a processing unit 510 (e.g. a semiconductor device) that includes a tap calculator 511. The tap calculator 511 may include a discarder circuit 512. A dual antenna receiver 580 may be coupled to the processing unit 510 and may include a J-tap equalizer 581. The dual antenna receiver 580 may include or be coupled to multiple antennas, such as a first antenna 542 and a second antenna 543. The dual antenna receiver 580 may enable the wireless device 500 to be compatible with a multiple-in, multiple-out (MIMO) communication network. The processing unit 510 may be coupled to a memory 532. The memory 532 may store data 535 and instructions 533 executable by the processing unit 510. The memory 532 may be a tangible (i.e., non-transitory) computer readable medium.

The wireless device 500 may also include a display controller 526 that is coupled to the processing unit 510 and to a display 528. A coder/decoder (CODEC) 534 can also be coupled to the processing unit 510. A speaker 536 and a microphone 538 can be coupled to the CODEC 534.

In a particular embodiment, the processing unit 510, the dual antenna receiver 580, the display controller 526, the memory 532, the CODEC 534, are included in a system-in-package or system-on-chip device 522. In a particular embodiment, an input device 530 and a power supply 544 are coupled to the system-on-chip device 522. Moreover, in a particular embodiment, as illustrated in FIG. 5, the display 528, the input device 530, the speaker 536, the microphone 538, the first antenna 542, the second antenna 543, and the power supply 544 are external to the system-on-chip device 522. However, each of the display 528, the input device 530, the speaker 536, the microphone 538, the first antenna 542, the second antenna 543, and the power supply 544 can be coupled to a component of the system-on-chip device 522, such as an interface or a controller.

Operation of the wireless device 500 may be similar to operation as described with reference to any of FIGS. 1-4. However, for the dual antenna receiver 580, an auto-covariance matrix may be zero-padded in blockwise fashion. For example, a 2 J×2 J auto-covariance matrix R may be divided into four J×J square matrices. Each of the four J×J square matrices may be zero-padded to size 2 J×2 J, yielding a zero-padded auto-covariance matrix R′ of size 4 J×4 J. The zero-padded auto-covariance matrix R′ may be approximated by a circulant approximation matrix R_{c}′. The zero-padded covariance matrix may be given by:

$${R}_{c}^{′} = [ \begin{matrix}{R}_{00 , c}^{′} & {( {R}_{01 , c}^{′ } )}^{H} \\ {R}_{01 , c}^{′} & {R}_{11 , c}^{′}\end{matrix} ] = [ \begin{matrix}{F}_{2 J}^{H} {D}_{00}^{′} {F}_{2 J} & {{F}_{2 J}^{H} ( {D}_{01}^{′} )}^{′} {F}_{2 J} \\ {F}_{2 J}^{H} {D}_{01}^{′} {F}_{2 J} & {F}_{2 J}^{H} {D}_{11}^{′} {F}_{2 J}\end{matrix} ]$$

which can be calculated as:

$$[ \begin{matrix}{F}_{2 J}^{H} & 0 \\ 0 & {F}_{2 J}^{H}\end{matrix} ] [ \begin{matrix}{D}_{00}^{′} & {( {D}_{01}^{′} )}^{H} \\ {D}_{01}^{′} & {D}_{11}^{′}\end{matrix} ] [ \begin{matrix}{F}_{2 J} & 0 \\ 0 & {F}_{2 J}\end{matrix} ]$$

For the dual antenna receiver 580, a channel impulse response vector may also be zero-padded in blockwise fashion:

$${\vec{h}}_{0}^{′} = {[ \begin{matrix}{0}_{J / 2 \times 1} \\ {\vec{h}}_{0} \\ {0}_{J / 2 \times 1}\end{matrix} ]}_{2 J \times 1} {\vec{h}}_{1}^{′} = {[ \begin{matrix}{0}_{J / 2 \times 1} \\ {\vec{h}}_{1} \\ {0}_{J / 2 \times 1}\end{matrix} ]}_{2 J \times 1} {\vec{h}}^{′} = {[ \begin{matrix}{\vec{h}}_{0}^{′} \\ {\vec{h}}_{1}^{′}\end{matrix} ]}_{4 J \times 1}$$

Multiple taps may be generated by a frequency domain operation based on R_{c}′ and \vec{h}′. For example, the multiple taps may be generated according to:

$${\vec{c}}_{FDE}^{′} = {( {R}_{c}^{′} )}^{- 1} {\vec{h}}^{′} = {[ \begin{matrix}{F}_{2 J}^{H} & 0 \\ 0 & {F}_{2 J}^{H}\end{matrix} ] [ \begin{matrix}{D}_{00}^{′} & {( {D}_{01}^{′} )}^{H} \\ {D}_{01}^{′} & {D}_{11}^{′}\end{matrix} ]}^{- 1} [ \begin{matrix}{F}_{2 J} & 0 \\ 0 & {F}_{2 J}\end{matrix} ] [ \begin{matrix}{\vec{h}}_{0}^{′} \\ {\vec{h}}_{1}^{′}\end{matrix} ]$$

where \vec{c}′_{FDE} is a time domain vector that includes the multiple taps.

The processing unit 510 may use the discarder circuit 512 to discard at least one of the multiple taps to generate updated filter taps for the J-tap equalizer 581. The updated filter taps may be used at the J-tap equalizer 581 to receive and equalize additional signals.

In conjunction with the disclosed systems and methods of FIGS. 1-5, an apparatus is disclosed that includes means for receiving a signal via a communication channel (e.g., the receiver 118 of FIG. 1, the receiver 302 of FIG. 3, and the dual antenna receiver 580 of FIG. 5), where the means for receiving includes an equalizer (e.g., the J-tap equalizer 120 of FIG. 1, the J-tap equalizer 304 of FIG. 3, and the J-tap equalizer 581 of FIG. 5). The apparatus further includes means for determining an N-point transform of channel data associated with the communication channel (e.g., the N-point transform circuit 108 of FIG. 1 and the first N-point FFT circuit 318 of FIG. 3) and means for determining an N-point transform of signal covariance data associated with the received signal (e.g., the N-point transform circuit 108 of FIG. 1 and the second N-point FFT circuit 319 of FIG. 3). The apparatus further includes means for performing an operation based on the transformed channel data and the transformed signal covariance data to generate a transform representation of multiple taps (e.g., the tap calculator 110 of FIG. 1, the tap calculator 322 of FIG. 3, and the tap calculator 511 of FIG. 5), means for determining an N-point inverse transform of the transform representation to generate multiple taps for use at an equalizer of the receiver (e.g., the N-point transform circuit 108 of FIG. 1 and the N-point inverse FFT circuit 320 of FIG. 3), and means for discarding at least one of the taps to generate updated filter taps for the equalizer (e.g., the discarder circuit 114 of FIG. 1, the discarder circuit 328 of FIG. 3, and the discarder circuit 512 of FIG. 5). Means for zero padding a channel impulse response vector to generate the channel data and for zero padding an auto-covariance matrix (e.g., the zero padding circuit 308 of FIG. 3) are provided. The apparatus further includes means for determining a circulant approximation of the zero-padded auto-covariance matrix to generate the signal covariance data (e.g., the approximator 310 of FIG. 3).

In conjunction with the disclosed systems and methods of FIGS. 1-5, a tangible computer readable medium (e.g., the memory 532 of FIG. 5) is disclosed that includes instructions (e.g., the instructions 533 of FIG. 5) executable by a processor (e.g., the processing unit 510 of FIG. 5). According to a particular illustrative embodiment, the instructions 533 are executable by the processing unit 510 to cause the processing unit 510 to receive a signal at the dual antenna receiver 580 or at a transceiver via a communication channel, to determine an N-point transform of channel data associated with the communication channel, and to determine an N-point transform of signal covariance data associated with the received signal. The instructions 533 may be further executable by the processing unit 510 to perform an operation based on the transformed channel data and the transformed signal covariance data to generate a transform representation of multiple taps. The processing unit 510 may further execute the instructions 533 to determine an N-point inverse transform of the transform representation to generate multiple taps for use at the J-tap equalizer 581 of the dual antenna receiver 580. The processing unit 510 may further execute the instructions 533 to discard at least one of the taps to generate updated filter taps for the J-tap equalizer 581. The instructions 533 may be further executable by the processing unit 510 to zero-pad a channel impulse response vector to generate the channel data, to zero-pad an auto-covariance matrix, and to determine a circulant approximation of the zero-padded auto-covariance matrix to generate the signal covariance data.

Those of skill would further appreciate that the various illustrative logical blocks, configurations, modules, circuits, and steps described in connection with the embodiments disclosed herein may be implemented as electronic hardware, computer processor executable instructions, or combinations of both. Various illustrative components, blocks, configurations, modules, circuits, and steps have been described above generally in terms of their functionality. Whether such functionality is implemented as hardware or software that is executable by a processing device depends upon the particular application and design constraints imposed on the overall system. Skilled artisans may implement the described functionality in varying ways for each particular application, but such implementation decisions should not be interpreted as causing a departure from the scope of the present disclosure.

The steps of a method or process described in connection with the embodiments disclosed herein may be embodied directly in hardware, in a software module executed by a processor, or in a combination of the two. A software module executable by a processor may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g., tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

1. A method comprising:
receiving a signal at a receiver via a communication channel;
determining an N-point transform of channel data associated with the communication channel to generate transformed channel data, wherein the channel data is provided as a channel impulse response vector zero padded at a beginning and end thereof to size N;
determining an N-point transform of signal data associated with the received signal to generate transformed signal data;
performing an operation based on the transformed channel data and the transformed signal data to generate a transform representation of multiple taps;
determining an N-point inverse transform of the transform representation to generate multiple taps for use at an equalizer of the receiver; and
discarding at least one of the multiple taps to generate updated filter taps for the equalizer.

2. (canceled)

3. The method of claim 1, wherein the signal data includes signal covariance data, and further comprising:
zero padding an auto-covariance matrix; and
determining a circulant approximation of the zero-padded auto-covariance matrix to generate the signal covariance data.

4. The method of claim 3, wherein the signal covariance data is a circulant approximation matrix.

5. The method of claim 1, wherein the N-point transform of the channel data and the N-point transform of the signal data are fast Fourier transforms, and wherein the N-point inverse transform is an inverse fast Fourier transform.

6. The method of claim 1, further comprising:
receiving a second signal at the receiver via the communication channel;
generating second taps based at least partially on second signal data associated with the received second signal; and
discarding at least one of the second taps to generate second updated filter taps to replace the updated filter taps at the equalizer.

7. An apparatus comprising:
a receiver including a J-tap equalizer;
an N-point transform circuit coupled to the receiver and configured to receive channel data and signal data from the receiver, wherein N is greater than J; and
a tap calculator coupled to receive transformed channel data output from the N-point transform circuit and to receive transformed signal data from the N-point transform circuit,
wherein the tap calculator includes a discarder circuit, and wherein an output of the discarder circuit is coupled to provide J updated filter taps to the J-tap equalizer;
wherein the channel data is provided as a channel impulse response vector zero padded at a beginning and end thereof to size N.

8. The apparatus of claim 7, wherein the N-point transform circuit includes:
a first N-point fast Fourier transform (FFT) circuit configured to transform the channel data;
a second N-point fast Fourier transform (FFT) circuit configured to transform the signal data; and
an N-point inverse fast Fourier transform (FFT) circuit configured to receive a transform representation of multiple taps output by the tap calculator and to inversely transform the transform representation.

9. The apparatus of claim 7, wherein the channel data corresponds to a communication channel and wherein the signal data includes signal covariance data associated with a signal received at the receiver via the communication channel.

10. The apparatus of claim 7, further comprising a zero padding circuit having an output coupled to an input of the N-point transform circuit, wherein the signal covariance data corresponds to a circulant approximation of a zero-padded auto-covariance matrix.

11. The apparatus of claim 7, further comprising an antenna coupled to the receiver, wherein the antenna, the receiver, the transform circuit, and the tap calculator are integrated within a wireless device, wherein the signal covariance data is based on a wireless signal received at the antenna via a wireless communication channel.

12. The apparatus of claim 11, wherein the signal covariance data includes a statistical measure of the wireless signal, and wherein the channel data includes a response characteristic of the wireless communication channel.

13. The apparatus of claim 12, wherein the statistical measure is a circulant approximation of a linear minimum mean squared error (LMMSE) matrix inverse, and wherein the response characteristic is a channel impulse response vector.

14. An apparatus comprising:
means for receiving a signal via a communication channel, wherein the means for receiving includes an equalizer;
means for determining an N-point transform of channel data associated with the communication channel to generate transformed channel data, wherein the channel data is provided as a channel impulse response vector zero padded at a beginning and an end thereof to size N;
means for determining an N-point transform of signal data associated with the received signal to generate transformed signal data;
means for performing an operation based on the transformed channel data and the transformed signal data to generate a transform representation of multiple taps;
means for determining an N-point inverse transform of the transform representation to generate multiple taps for use at an equalizer of the receiver; and
means for discarding at least one of the multiple taps to generate updated filter taps for the equalizer.

15. The apparatus of claim 14, further comprising means for zero padding an auto-covariance matrix.

16. The apparatus of claim 15, further comprising means for determining a circulant approximation of the zero-padded auto-covariance matrix to generate the signal data.

17. A tangible computer readable medium including instructions executable by a processor to cause the processor to:
receive a signal at a receiver via a communication channel;
determine an N-point transform of channel data associated with the communication channel to generate transformed channel data, wherein the channel data is provided as a channel impulse response vector zero padded at a beginning and an end thereof to size N;
determine an N-point transform of signal data associated with the received signal to generate transformed signal data;
perform an operation based on the transformed channel data and the transformed signal data to generate a transform representation of multiple taps;
determine an N-point inverse transform of the transform representation to generate multiple taps for use at an equalizer of the receiver; and
discard at least one of the multiple taps to generate updated filter taps for the equalizer.

18. (canceled)

19. The tangible computer readable medium of claim 17, wherein the instructions are further executable by the processor to:
zero-pad an auto-covariance matrix; and
determine a circulant approximation of the zero-padded auto-covariance matrix to generate the signal data.

20. A system comprising:
a communication device, wherein the communication device includes:
a receiver configured to receive a signal via a communication channel, wherein the receiver includes an equalizer;
a transform circuit configured to determine an N-point transform of channel data associated with the communication channel to generate transformed channel data and further configured to determine an N-point transform of signal data associated with the received signal to generate transformed signal data, wherein the channel data is provided as a channel impulse response vector zero padded at a beginning and an end thereof to size N; and
a tap calculator configured to perform an operation based on the transformed channel data and the transformed signal data to generate a transform representation of multiple taps,
wherein the transform circuit is further configured to perform an N-point inverse transform of the transform representation to generate multiple taps for use at an equalizer of the receiver, and
wherein the tap calculator includes a discarder circuit configured to discard at least one of the multiple taps to generate updated filter taps for the equalizer; and
a network device, wherein the network device is configured to transmit the signal to the communication device via the communication channel.

21. The system of claim 20, wherein the communication device is a wireless device, and wherein the network device includes a base station transceiver.

22. The system of claim 21, wherein the receiver is a single antenna receiver.

23. The system of claim 21, wherein the receiver is a multiple antenna receiver.

24. The system of claim 20, wherein the equalizer is a frequency domain equalizer.

25. A semiconductor device comprising:
an N-point transform circuit coupled to receive channel data and signal data, wherein the channel data is provided as a channel impulse response vector zero padded at a beginning and an end thereof to size N; and
a tap calculator coupled to receive transformed channel data and transformed signal data from the N-point transform circuit,
wherein the tap calculator includes is coupled to provide J updated filter taps to a J-tap equalizer, wherein J is greater than N.

26. The semiconductor device of claim 25, wherein the tap calculator includes a discarder circuit, wherein an output of the discarder circuit is coupled to provide the J updated filter taps to the J-tap equalizer.

27. The semiconductor device of claim 26, wherein the receiver, the N-point transform circuit, and the tap calculator are integrated within a wireless device.

28. The semiconductor device of claim 25, further comprising a receiver configured to receive a signal, wherein the receiver includes the J-tap equalizer.

29. A method comprising:
performing an operation based on transformed channel data and transformed signal data to generate a transform representation of multiple taps, wherein the transformed channel data and the transformed signal data correspond to channel data provided as a channel impulse response vector zero padded at a beginning and an end thereof to size N, and signal data;
determining an inverse transform of the transform representation to generate multiple taps for use at an equalizer of the receiver; and
discarding at least one of the multiple taps to generate updated filter taps for the equalizer.

30. The method of claim 29, wherein the inverse transform is an N-point inverse transform, wherein the equalizer is a J-tap equalizer, and wherein N is greater than J.
